(19) United States
(12) Patent Application Publication
(10) Pub. No.: US 2001/0030744 A1
(43) Pub. Date: Oct. 18, 2001

(54) Method of simultaneously applying multiple illumination schemes for simultaneous image acquisition in an imaging system

(75) Inventor: Tzyy-Shuh Chang, Ann Arbor, MI (US)

Correspondence Address: DYKEMA GOSSETT PLLC, 39577 WOODWARD AVENUE, BLOOMFIELD HILLS, MI, 48304-2820, US

(73) Assignee: OG Technologies, Inc.

(21) Appl. No.: 09/740,270

(22) Filed: Dec. 19, 2000

Related U.S. Application Data
(60) Provisional application No. 60/173,186, filed on Dec. 27, 1999.

(51) Int. Cl. G01N 21/00

(52) U.S. Cl. 356/237.3; 250/559.36

(57) ABSTRACT

A method is used for imaging applications so that one can simultaneously apply multiple illumination schemes and simultaneously acquire the images, each associated with one of the multiple illumination schemes. The illumination schemes can be, but not limited to, any combination of reflective illumination, transmitive illumination (backlighting), bright field illumination, dark field illumination, diffused illumination, cloudy-day illumination, and structured illumination. The radiation can be in any wavelengths, ranging from sonic waves, ultra sound, radio waves, microwaves, infrared, near infrared, visible light, ultra violet, X-rays, and gamma rays. The radiation of each of the illumination schemes used in an imaging application is modulated, that is, affixed with a unique signature. One or more imaging devices can be used to collect the radiating rays simultaneously after the rays interact with the object(s). The image signal(s) are then demodulated, separated into several images, each is associated with an illumination scheme, based on the signatures. A preferred embodiment is to use radiation wavelengths of 430 nm, 575 nm or 670 nm as the signatures.

### RELATED APPLICATIONS

This application claims the benefit of U.S. provisional application Ser. No. 60/173,186 filed Dec. 27, 1999.

### BACKGROUND OF THE INVENTION

1. Technical Field

The present invention relates generally to image acquisition systems, and, more particularly, to an image acquisition system having multiple illumination schemes for simultaneous image acquisition.

2. Description of the Related Art

There are many different ways to illuminate object(s) in order to capture information about the object. The type of information that can be obtained by a specific illumination scheme depends upon the nature of the illumination scheme.

In imaging applications, in which one or more imaging devices such as CCD cameras and optical scanners are used to gather object information carried by radiation, it is well known that different illumination schemes result in dramatically different images from the same object. Examples of different illumination schemes include, but are not limited to, a transmitive illumination system 10 and a reflective illumination system 12. For instance, an object can be illuminated utilizing a transmitive illumination system 10, as described below in FIG. 1.

In transmitive illumination, an object 14 is placed between an illumination source 16, such as a light, and an imaging device or a signal receiver, such as a camera 18. In this arrangement, the contour boundaries of the object will be well defined while the surface details are poorly shown in the image. An image processing unit 20 is also shown.

In transmitive illumination scheme 10, the illumination source(s) 16 can be (a) conditioned or non-conditioned; (b) structured or non-structured; (c) collimated or scattered; (d) uniform or non-uniform; or (e) monochromatic or color. Different combinations of the foregoing can be used that allow the user to accomplish specific system requirements. In addition, there are any number of otherwise conventional optical components such as, but not limited to, lenses, mirrors and diffusers (not shown) that can be used in the design of transmitive illumination scheme 10 to accomplish specific system requirements.

Another type of illumination is reflective illumination (FIG. 2), in which the radiation is projected on the object surface and reflected back to the imaging device. Reflective illumination allows the imaging device 18 to detect the surface characteristics of object 14. In a reflective illumination scheme, the illumination source(s) 16 can be (a) conditioned or non-conditioned; (b) structured or non-structured; (c) collimated or scattered; (d) uniform or non-uniform; or (e) monochromatic or color. Different combinations of the foregoing can be used that allow the user to accomplish specific system requirements. In addition, there are any number of otherwise conventional optical components such as, but not limited to, lenses, mirrors and diffusers (not shown) that can be used in the design of the reflective illumination scheme to accomplish specific system requirements. The reflective illumination can be further broken down into several types such as bright field illumination, dark field illumination and cloudy-day illumination.

In bright field illumination, as shown in FIG. 3, most of the radiation or at least a large portion thereof originating from the source(s) 16 strike object 14 and then is reflected to imaging device 18. The angle of projection is deliberately selected such that the desired reflective path is established. This illumination scheme is often used to detect surface characteristics such as color patterns, marks, and/or discoloration.

In dark field illumination, as shown in FIG. 4, the illumination source projects a signal 22 upon object 14 that in most instances will be reflected away (e.g., ray 24) from imaging device 18. A surface anomaly 26, such as surface sculptures, foreign objects, or contaminants, may then be imaged by imaging device 18, due to acquisition of scattered signals 28 caused by the surface anomalies. The scattered signals 28 comprise radiation reflected by the surface anomalies towards the imaging device.

In cloudy-day illumination, the illumination source (s) are arranged such that there exists no shadow of the object 14.

It is often the case that different aspects of an object or objects, such as surface anomalies and contour boundaries, are desired to be observed. For instance, it may be desired to measure the distance between two boundary lines accurately with good boundary definition using transmitive illumination as shown in FIG. 1. At the same time, it may also be desirable to detect surface anomalies using reflective illumination on the object(s) as shown in FIG. 4. In some known applications, images sequentially obtained using different illumination schemes are overlapped with an image processing operation, such as a difference operation, to extract the intended information. For instance, a dark field illuminated image and a bright field illuminated image may be overlapped to extract the surface defects on a processed semiconductor wafer.

Other known approaches of applying different illumination schemes are all sequential approaches. One known approach is to have multiple imaging stations, each with a particular illumination scheme. For instance, a first station is equipped with transmitive illumination so that the dimensions of an object(s) can be detected. Then, the object(s) are moved to a second station in which surface discoloration can be detected using bright field illumination. Afterward, the object(s) are moved to a third station where surface scratch marks can be detected using dark field illumination.

Another known approach is to have multiple illuminating devices in an imaging station, in which the illuminating devices can be controlled to provide different illumination schemes. The object(s) are first placed in this station. One illumination scheme, for instance, bright field, is applied on and to the objects and an image is taken. Then, another illumination scheme, for instance, a dark field illumination, is applied onto the objects and another image is taken.

Still yet another known approach is to have multiple sets of imaging devices and illuminating devices in an imaging station. The object(s) are first placed in the station. One set of the imaging and illuminating devices, for example, a CCD camera and a light for dark field illumination, is applied onto the object(s), or a portion of the object(s), for taking a first image. Then, another set of the imaging and illuminating devices, for example, a CCD camera and a light for transmitive illumination, is applied onto the object(s), or the same portion of the object(s), for taking a second image.

The sequential nature of conventional illumination schemes and image acquisition systems provide obstacles or limitations on how quickly image processing can take place where multiple features of the object are desired to be imaged. Additionally, where objects are moved between stations, an increased amount of damage to the object may occur, due to the increased material handling. Also, multiple stations increase cost. Finally, accuracy is impaired with respect to image overlap since different data is used to image overlap since different data is used for each object feature.

U.S. Pat. No. 4,595,289 to Feldman et al. disclose a dual illumination system that uses two light sources, having two separate wavelengths, to illuminate an object. Feldman et al. further disclose that such illumination may occur simultaneously. However, the system of Feldman et al. uses distinct light signal paths, increasing the amount of optical components/cameras, and the like that is required. Every optical component is different even when the components are made to the same specifications. Therefore, different light paths and optical components will generate different image distortions, impairing the applications of the approach of Feldman et al.

Accordingly, there is a need for an imaging system, or portions thereof, that minimizes or eliminates one or more of the problems set forth above.

### SUMMARY OF THE INVENTION

It is an object of the present invention to provide an imaging system that provides a solution to the above-identified problems. The invention simultaneously applies different illumination schemes to an object(s) so that different aspects of the object(s), such as the boundaries and the surface defects, can be detected simultaneously.

A system according to the invention provides the following advantages:

(i) Saves time by simultaneous image acquisition thereby minimizing material handling;

(ii) Provides improved accuracy for image overlap by using the same datum and the same image collecting optics;

(iii) Reduces damage to the object(s) by minimizing material handling; and

(iv) Lowers costs by having only one mechanical station for all the imaging needs.

A system for observing an object in accordance with the present invention includes first and second radiation projectors, an image acquisition device, and an controller. The radiation projectors are configured to produce first and second radiation signals, respectively, having different first and second wavelengths. The image acquisition device is arranged to have the object in a field of view and is further configured to simultaneously capture radiation signals having the first and second wavelengths to produce an image of the object. The controller is configured to cause the first and second radiation projectors to simultaneously illuminate the object with the first and second radiation signals and control the image acquisition device to produce the image of the object in timed relation therewith.

### BRIEF DESCRIPTION OF THE DRAWINGS

FIG. 1 is a schematic diagram view of a conventional transmitive illumination (back lighting) scheme used in an imaging application;

FIG. 2 is a schematic diagram view of a conventional reflective illumination scheme used in an imaging application;

FIG. 3 is a schematic diagram view of a conventional bright field illumination scheme used in an imaging application;

FIG. 4 is a schematic diagram view of a conventional dark field illumination scheme used in an imaging application;

FIG. 5 is a schematic diagram view of an imaging system of the present invention, illustrating N modulated signal projectors are incorporated with an imaging device for the image acquisitions.

FIG. 6 is a schematic diagram view of a preferred embodiment of the present invention having radiating wavelengths as unique signatures;

FIG. 7 is a schematic diagram view of another embodiment of the present invention showing two (2) illumination schemes;

FIG. 8 is a schematic diagram view of yet another embodiment of the present invention showing four (4) illumination schemes;

FIG. 9 is a schematic diagram view of still another embodiment of the present invention in which one of the radiation sources is used to support a plurality of projectors via a light delivering mechanism;

FIG. 10 is a schematic diagram view showing a configuration for an imaging device with three (3) CCD chips for simultaneously collecting images with simultaneous illumination schemes;

FIG. 11 is a schematic diagram view showing a plurality of cameras configured to simultaneously collect corresponding images with simultaneous illumination schemes; and

FIG. 12 is a schematic diagram view showing still yet another embodiment having a plurality of cameras with multiple illumination schemes.

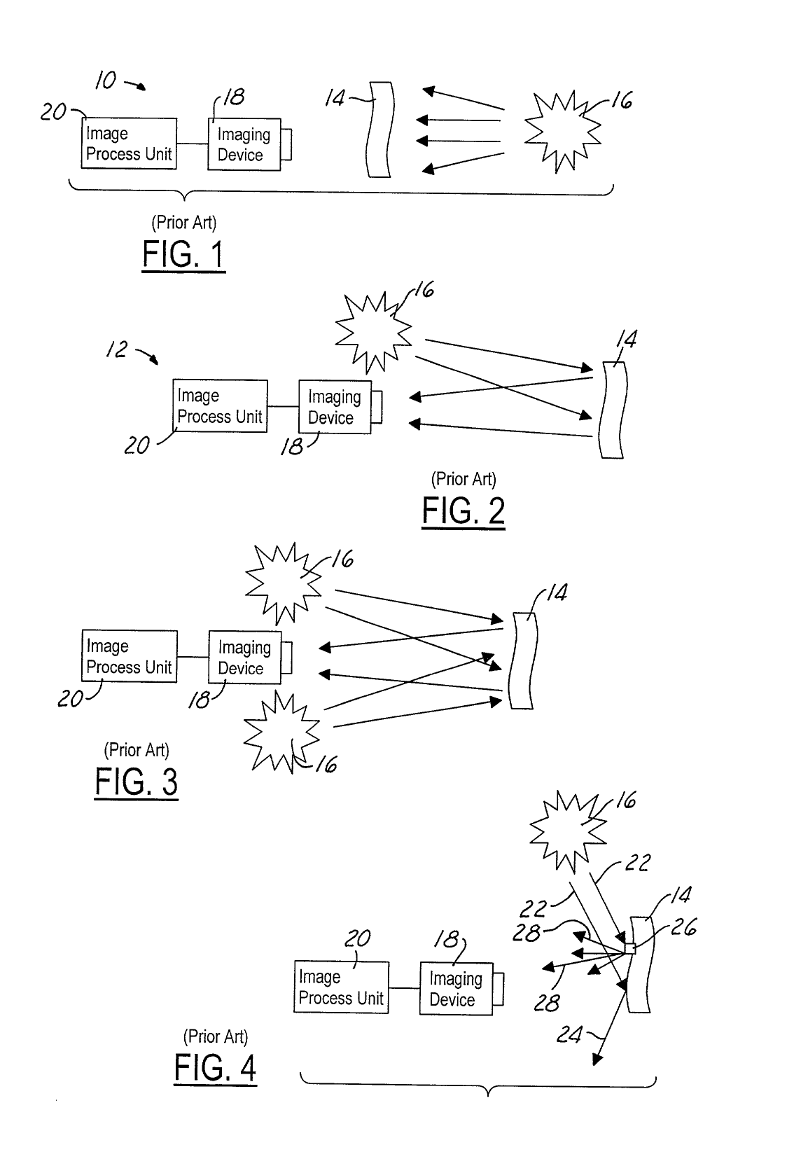

### DETAILED DESCRIPTION OF THE INVENTION

This invention is an imaging system that permits the simultaneous illumination and simultaneous image acquisition of one or more objects with two or more illumination schemes.

An “imaging system” as the term is used herein means any system that is capable of receiving, and/or acquiring, and/or storing, and/or processing, and/or analyzing, and/or transmitting, and/or transferring, image data from or about, an object or objects which have been either illuminated by (a) an external radiation source or (b) is itself a self-radiating object. An imaging system in this invention includes two or more illumination sources.

The invention consists of either (1) adding a unique, discernable signature (hereinafter referred to as the signature(s)) to the radiation which emanates from an object or objects and/or (2) identifying any such signature that is inherent in the radiation so that the imaging system can differentiate the radiation signals from different illumination sources based on the unique signature of each of the radiation signals. The invention allows the simultaneous illumination and simultaneous acquisition of images from one or more objects using two or more illumination schemes simultaneously.

In this invention, there can be N illumination sources (hereinafter referred to as the “signal projectors”) in an imaging system, where N is an integer that is greater than or equal to 2. Each signal projector is generally part of a specific illumination scheme; that is, there can be N illumination schemes co-existing and used simultaneously in an imaging system. A signal projector can be facilitated by one radiation source. It is also possible that more than one signal projector can be facilitated by a single radiation source.

Generally, each of the signal projectors is equipped with a modulation device. The modulation device blends a unique, discernible signature into the radiation signal being projected by the signal projector. The modulation device can be either an electronic device, an electrical device, a mechanical device, an optical device, an opto-mechanical device, a software device, or any combination of the above. The modulated projection signals are then used to illuminate the intended object(s). In some cases in which a signal projector inherently carries a unique signature, the modulation process is not necessary.

Each of the projection signals is designed to deliver a specific illumination scheme, such as dark-field illumination, to the intended object(s). The projection signals will then interact with the intended object(s), and be modified by such interactions. After the interaction, the projection signals are collected by a signal image acquisition device (imaging device) simultaneously. The imaging device is designed such that it can simultaneously detect all the projection signals, including the modulation signatures blended in the projection signals and the modifications incurred by the interactions with the intended object(s). The imaging device is also designed such that it can discern the modulation signatures, distinguishing one from the other, and conduct a demodulation process. Such demodulation process will allow the said imaging device to extract images resulted from different illumination schemes.

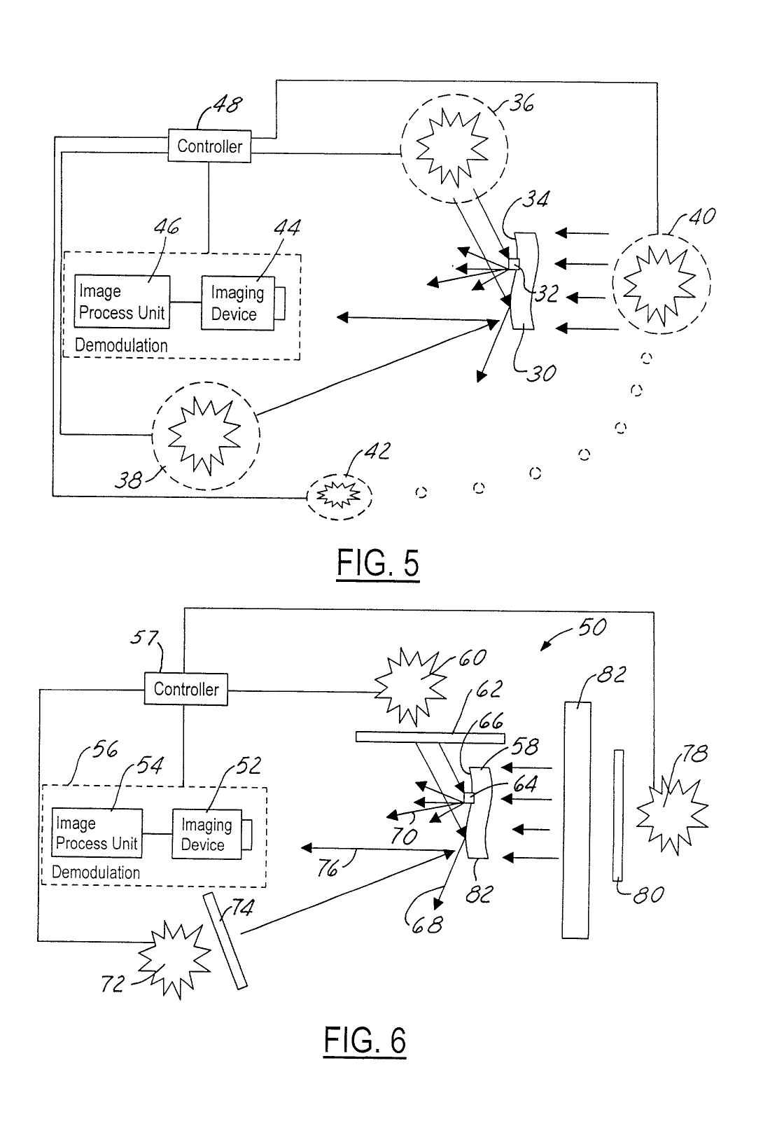

Referring now to the drawings wherein like reference numerals are used to identify identical components in the various views, in FIG. 5, an object 30 having a surface characteristic 32 is to be observed. It is desired to observe the boundaries of object 30 accurately. It is also desired to simultaneously observe surface characteristics 32, such as foreign objects and discoloration, of object 30. It is further desired to simultaneously detect the height of certain patterns on a surface 34 of object 30. In order to satisfy all the desires, it is determined that N illumination schemes are necessary to facilitate acquisition of the required information. In the illustrated embodiment, a first projector 36 is used to provide dark field illumination so that a foreign object or the like can be detected. A second projector 38 is used to provide bright field illumination so that any surface discoloration can be detected. A third projector 40 is used to provide transmitive illumination so that the boundaries of object 30 can be accurately defined. Further projectors may be included to achieve predetermined, desired illumination characteristics. An N-th projector 42 is used to provide a structured line illumination so that the scheme of triangulation can be used to determine the wavy profile of the object surface 34.

The radiation signal projectors 36, 38, 40, . . . , 42 may comprise radiation sources capable of various emission types and can be sonic, electromagnetic, IR, visible light, UV, X-ray, structured or non-structured, scattered or collimated, color or monochromatic. In one embodiment, sources 36, 38, 40, . . . , 42 may comprise one of a metal-halide lamp, a Xenon lamp, and a halogen lamp, each a relatively broadband light source, in connection with a filter, to be described below. Lasers may be used (i.e., specific wavelength devices) and the need for a filter can be avoided. Each signal projector 36, 38, 40, . . . , 42 is modulated and/or selected in a specific way so that the radiation from a particular signal projector carries a unique signature and can be identified after an image acquisition device 44 collects all the radiation signals. The imaging device 44 consists of one or more radiation sensors, such as, but not limited to, sonic detectors, CCD chips, and IR imaging arrays. The radiation sensor(s) in imaging device 44 are arranged such that the radiation signals from all the radiation projectors 36, 38, 40, . . . , 42 can be collected simultaneously. It is necessary to demodulate the radiation signals based on the signatures so that information carried by different illumination schemes can be differentiated. The demodulation process can be performed before or after the radiation signals reach the radiation sensor(s). FIG. 5 further shows an image processing unit 46. FIG. 5 further shows a controller 48. Controller 48 is configured to cause the radiation projectors (or at least two or more of them) to simultaneously illuminate object 34 the respective radiation signals generated by the projectors. Further, the controller 48 is further configured to control the image acquisition device 44/46 to produce an image of the object in timed relation (i.e., substantially simultaneously with) with the illumination. While controller 48 is shown as separate from image process unit 46, these functions may be merged into a single control unit, such as a general purpose digital computer suitably programmed to achieve the functions described herein.

FIG. 6 shows a preferred embodiment of the invention which uses an optical modulation scheme, namely, system 50. In this system, as shown above, a color CCD camera (with an optical lens) 52 is used as the imaging device. Camera 52 is coupled to an image process unit 54, forming a demodulation block 56. Also shown is a controller 57, which operates in the same manner as described above for controller 48. In color camera 52, color pixels are arranged in a plenary array. Each color pixel typically consists of several, 3 or more, monochromatic pixels. There would be a color filter in front of each monochromatic pixel; this color filter determines which color, typically one of red, green, and blue, this monochromatic pixel is detecting the intensity of. With the color filters, radiation at a wavelength of 435 nm (blue light) can only be detected by the monochromatic pixels whose color filters are blue, but not other monochromatic pixels. Similarly, radiation at a wavelength of 575 nm (green light), or 670 nm (red light), can only be detected by the monochromatic pixels whose color filters are green, or red. These color filters, red, green, or blue serve as the demodulation devices on the imaging device.

The image acquired by way of camera 52 can be digitized and processed by image processing unit 54, which may comprise a computer or similar devices. In processing unit 54, the three portions of a color image, the red image, the green image, and the blue image, can be separated. Each of the three monochromatic images carries the optical characteristics of an object 58, resulting from different illumination schemes.

There are three illumination schemes used in the embodiment of FIG. 6. The first illumination scheme is a dark field illumination, facilitated by a metal-halite light source 60 and an interference filter 62 at 575 nm (green). A metal-halite light source is a white-light light source. That is, its radiation contains multiple wavelengths. Among the radiating wavelengths of metal-halite light source 60, there are three significant peaks, at 435 nm, 550 nm, and 575 nm, respectively. This white light radiation from source 60 is modified (modulated) by passing through filter 62. After passing through filter 62, the radiation from source 60 has only a single wavelength, 575 nm. This mentioned wavelength is the signature of the radiation from filter 62 that is unique and discernible in the imaging device 52. Imaging device 52 can receive the signal from illumination source 60 in its GREEN plane of the resulting color image. This illumination is configured to detect surface anomalies, such as a foreign object 64 on a surface 66 of object 58. If surface 66 of object 58 is free of anomalies, the radiation emanating from filter 62 will be reflected away from the imaging device 52, into a direction of ray designated 68. When the radiation from filter 62 strikes anomaly 64, the radiation is scattered into the directions of rays 70. Some of the scattered radiation can be detected by imaging device 52.

The second illumination scheme is structured illumination, facilitated by a second source comprising a laser diode 72 or the like that radiates at a wavelength of 670 nm (red), and a line generating optic 74. The modulation is inherently built in the radiation source 72, as laser 72 is a monochromatic laser. The wavelength of 670 nm is the signature of the radiation from laser 72 that is unique and discernible in the imaging device 52. Imaging device 52 can receive the signal 76 from this illumination source in its RED plane of the resulting color image. This structured illumination is configured to measure the profile of surface 66 of object 52.

The third illumination scheme is transmitive illumination, facilitated by a third source comprising a metal-halite light source 78 and an interference filter 80 at 435 nm (blue). The white light radiation from source 78 is modified (modulated) by passing through filter 80. After passing through filter 80, the radiation from source 78 has only a single wavelength, 435 nm. This mentioned wavelength is the signature of the radiation from source 78 that is unique and discernible in the imaging device 52. Imaging device 52 can receive the signal from this illumination source in its BLUE plane of the resulting color image. This illumination is designed to define contour boundaries 82 of object 58. The radiation from a light source, such as source 78, can be further modified by one or more optical components, such as an optical screen 82. Screen 82, in this particular embodiment, comprises a condensing lens (not shown) and a diffuser (not shown) to deliver a uniform light panel for transmitive illumination. Screen 82, in different embodiments, can have different arrangements and components.

In system 50, the radiation rays from sources 60, 72 and 78 strike object 52 simultaneously. The radiation rays interact with the optical properties of object 52. Nevertheless, the unique signatures of these radiation rays, the corresponding wavelengths, are not affected by such interactions. After the interactions, the radiation rays are collected by the imaging device 52. In camera 52, the radiation rays are demodulated by the color pixels. Within each color pixel, a portion is sensitive only to red light, such as the 670 nm radiation from source 72, a portion is sensitive only to green light, such as the 575 nm radiation from source 60 (and filter 62), and a portion is sensitive only to blue light, such as the 435 nm radiation from source 78 (and filter 80).

In an alternate embodiment, interference filters (not shown), instead of regular color filters, are placed in front of the monochromatic pixels. The interference filters can have selected wavelengths as desired for the imaging application. It is also possible to have less (such as 2) or more (such as 4) types of interference (or color) filters used in a color pixel.

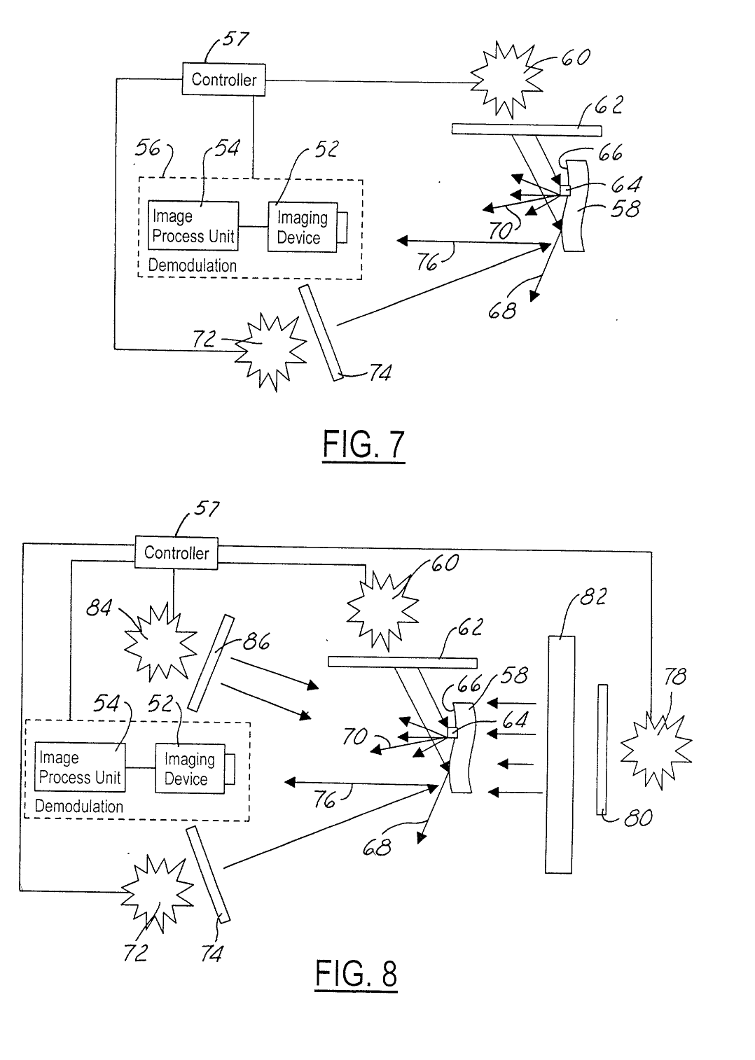

FIG. 7 illustrates an implementation with only 2 simultaneously illumination schemes, and thus only two types of interference (color) filters are needed in a color pixel.

The schematic shown in FIG. 8 is an implementation with 4 illumination schemes. In this implementation, four types of interference (color) filters are needed in a color pixel. In this embodiment, a fourth source comprising a metal-halite light source 84 and an interference filter 86 at a wavelength of 550 nm are provided. Source 84 and filter 86 facilitate bright field illumination to object 58. In this embodiment, imaging device 52 is modified. The green color filters in camera 52 are not effective in differentiating the radiation rays from source 60 (575 nm) and source 84 (550 nm). These green color filters in camera 52 must be replaced by two types of interference filters, one at 550 nm and another at 575 nm. That is, a color pixel in camera 52 has at least four monochromatic pixels, one with a red color filter, one with a blue color filter, one with a 550 nm interference filter, and one with a 575 nm interference filter.

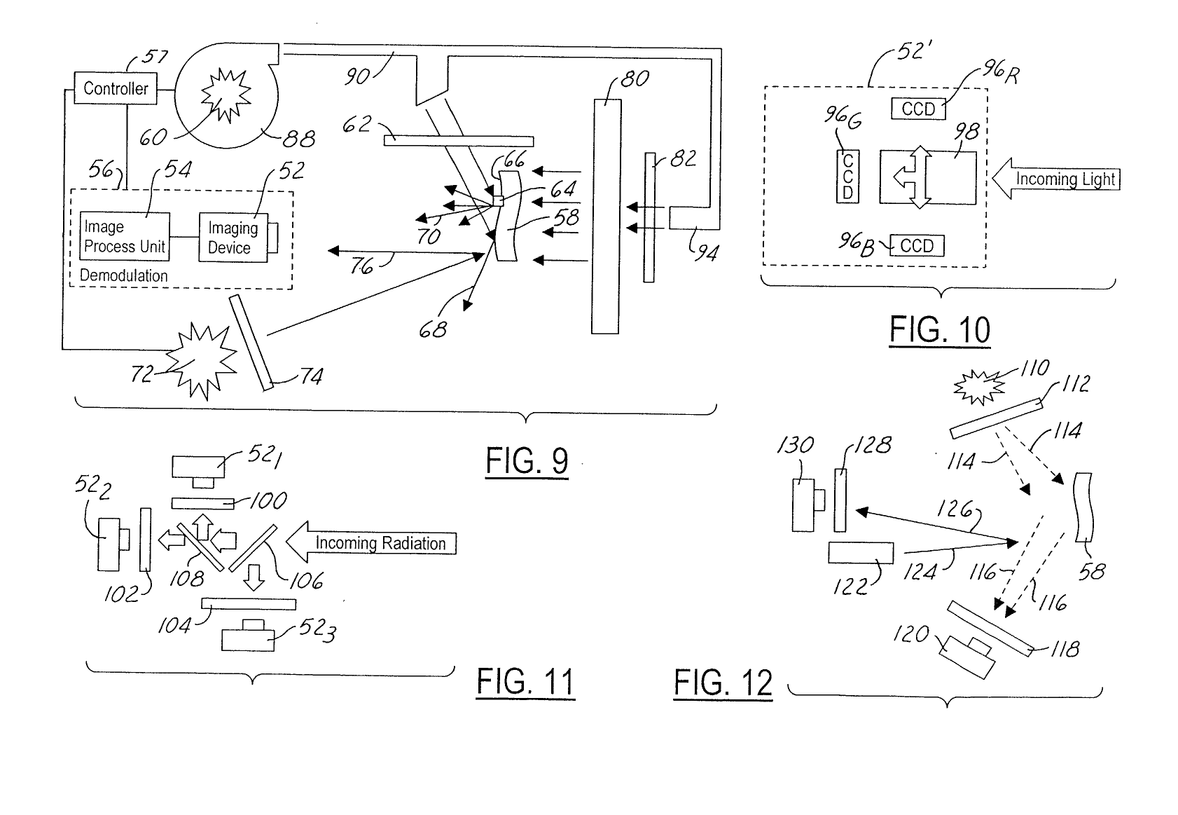

It is also possible to have one radiation source for two or more radiation projectors. In the schematic shown in FIG. 9, a light focusing device 88 is used to put the radiation from source 60, a metal-halite light source, into a light guide 90. Light guide 90 can be a fluid-based light guide, a periscope, an optical fiber bundle, or other devices having similar functionality. A portion of the light is delivered by light guide 90 to a projector 92 and another portion of the light is delivered by light guide 90 to a projector 94.

It is also possible to use a color camera 52′ that is made of multiple CCD chips 96_{R}, 96_{G}, and 96_{B} such as a 3-chip CCD camera. In this arrangement, there will be a prism 98 that separates the red, green, and blue light, and deliver the light of each color to a respective one of the CCD chips.

It is possible, for those who are skilled in the art, to have an interference filter (not shown) installed in front of each CCD chip 96_{R}, 96_{G}, and 96_{B} in this configuration. It is also possible, for those who are skilled in the art, to have one or more CCD chips, with associated interference filters, installed in this configuration.

In another embodiment, multiple CCD cameras 521, 522, 523 are provided in the imaging device 52, as shown in FIG. 11. In this case, the radiation to be collected is split using beam splitters 106, 108 into several copies with each directed to a respective CCD camera 52₁, 52₂, 52₃. A respective interference filter 100, 102, 104 are installed in front of each CCD camera. In the illustrated embodiment, these filters 100, 102 and 104 filter at 670 nm, 575 nm, and 435 nm, respectively. These cameras can be used in a synchronous mode, for grabbing images at exactly the same time, or in an asynchronous mode.

In another embodiment, multiple CCD cameras in the imaging application, as shown in FIG. 12. The radiation to be collected is directed into several cameras with interference filters in front of the cameras. The cameras are positioned at the best locations with the best attitudes to accept the intended radiation signals. These cameras can be used in a synchronous mode, for grabbing images at exactly the same timing, or an asynchronous mode. FIG. 12 shows a radiation source 110, such as a metal-halite lamp, proximate an interference filter 112, configured at 435 nm. Light rays 114 emerging from filter 112 impinge on object 58, producing reflected light rays 116. A corresponding interference filter 118, configured at 435 nm, its only light at such wavelength passing therethrough. Imaging device, such as CCD camera 120, is disposed proximate filter 118, and permits capture the reflected radiation. Likewise, FIG. 12 further shows another radiation source, such as a laser line generator 122, configured to radiate at 670 nm, shown in schematic fashion as generated light ray 124. Reflected ray 126 passes through an interference filter 128, a 670 nm interference filter, and thence to CCD camera 130.

For instance, a semiconductor wafer inspection station can utilize the simultaneous illumination technology to conduct both the inspections facilitated by dark field illumination and bright field illumination. Furthermore, the images obtained using different illumination schemes can be accurately cross-referenced (overlapped) for better defect detection. The inspection throughput is increased because image acquisition is done simultaneously. The risk of damaging the wafers is lowered because the wafers are not moved from one station to another.

In another aspect of the present invention, problems caused by ambient light are minimized or eliminated. Ambient light, such as sunlight, indoor lighting, or reflection/shadow from a person walking by the imaging site, can influence the performance of a machine vision system. According to this aspect of the present invention, the projected light from sources 36, 38, 40, . . . , 42, in this alternate embodiment, are modulated. Modulation may occur, for example, by way of frequency modulation (FM) or a particular wavelength. Any ambient light can be removed through, for example, a difference operation: light (on)−light (off=ambient_light). Through the foregoing, the machine vision system can see just the projected light.

The imaging system of the present invention can be used in the semiconductor industry for wafer inspection, either for inspecting non-patterned wafers or patterned wafers. The imaging system of the present invention can also be used in the semiconductor industry for the inspection of printed circuit boards used in chip packaging. The imaging system of the present invention can be used in the flat panel display industry for panel and circuit inspection. The imaging system of the present invention can be used in the printed circuit board industry for product inspection. The imaging system of the present invention can be used in the automotive industry for component inspection, such as, but not limited to, engine bearings and pistons, inspection.

Those who are skilled in the art will also appreciate the fact that imaging device(s), and/or camera(s) in any formats, standard or non-standard, such as, but not limited to, RS170, CCIR, NTSC, PAL, line scan, area scan, progressive scan, digital, analog, time-delay integration, and others, can be incorporated into this invention, including the preferred embodiments herein described.

1. A system for observing an object comprising:
a first radiation projector configured to produce a first radiation signal having a first wavelength;
a second radiation projector configured to produce a second radiation signal having a second wavelength different from said first wavelength;
an image acquisition device arranged to have the object in a field of view thereof and that is configured to simultaneously capture radiation signals having said first and second wavelengths to produce an image of the object; and
a controller configured to cause said first and second radiation projectors to simultaneously illuminate the object with said first and second radiation signals and control said image acquisition device to produce the image of the object in timed relation therewith.

2. The system of claim 1 wherein said first and second wavelengths comprise one of audible sound wavelengths, ultrasound wavelengths, radio wavelengths, infrared wavelengths, visible light wavelengths, ultraviolet light wavelengths and X-ray wavelengths.

3. The system of claim 1 wherein said first and second radiation projectors are coupled to a first light source by way of a waveguide.

4. The system of claim 3 wherein said light guide comprises at least one of an optical fiber, a periscope and a sonic tube.

5. The system of claim 1 wherein said first and second radiation projectors comprise a wideband source and respective interference or color filter selected so as to establish said first and second wavelength radiation signals.

6. The system of claim 1 wherein said first and second radiation projectors comprise a respective radiation source that directly produces radiation having said first and second wavelengths, respectively.

7. The system of claim 6 wherein said respective radiation sources comprises first and second lasers.

8. The system of claim 1 wherein said image acquisition device comprises a color charge coupled device (CCD) camera.

9. The system of claim 1 wherein said image acquisition device comprises a monochromatic camera.

10. The system of claim 1 wherein said image acquisition device comprises a color camera having one CCD.

11. The system of claim 10 wherein said color camera comprises a plurality of CCD chips.

12. The system of claim 1 wherein said first and second radiation sources include means for adding said first and second wavelength signals to respective base radiation signals.

13. The signature adding process, as mentioned in claim 12, can be amplitude modulation.

14. The signature adding process, as mentioned in claim 12, can be frequency modulation.

15. The signature adding process, as mentioned in claim 12, can be phase-lock loops.

16. The system of claim 12 wherein one of said first and second sources are arranged relative to said object and image acquisition device for dark field illumination.

17. The system of claim 12 wherein one of said first and second sources are arranged relative to said object and image acquisition device for bright field illumination.

18. The system of claim 12 wherein one of said first and second sources are arranged relative to said object and image acquisition device for transmitive illumination.

19. The system of claim 12 wherein one of said first and second sources are arranged relative to said object and image acquisition device for structured illumination.

20. The system of claim 12 wherein one of said first and second sources are arranged relative to said object and image acquisition device for cloudy-day illumination.

21. The system of claim 12 wherein one of said first and second sources are arranged relative to said object and image acquisition device to detect surface anomalies on the surface(s) of the object(s) such as, but not limited to, nicks, scratches, polishes, foreign objects, and sculptures.

22. The system of claim 12 wherein one of said first and second sources are arranged relative to said object and image acquisition device to detect surface discoloration on the surface(s) of the object(s), such as, but not limited to, colored marks, prints, and material differences.

23. The system of claim 12 wherein one of said first and second sources are arranged relative to said object and image acquisition device to detect the boundaries and/or edges of (a) the object(s), and/or (b) the feature(s) on the object(s).

24. The system of claim 12 wherein one of said first and second sources are arranged relative to said object and image acquisition device to detect the surface profile of the object(s).

25. The system of claim 12 wherein one of said first and second sources are arranged relative to said object and image acquisition device to detect and verify the integrity of features on the object(s).

26. The system of claim 1 wherein said controller is configured to modulate said radiation generated by said radiation projectors in such a way as to allow ambient light impinging on the object to be removed.
